(19) United States
(12) Patent Application Publication
(10) Pub. No.: US 2015/0131987 A1
(43) Pub. Date: May 14, 2015

(54) SYSTEM AND METHOD FOR IN-BAND FREQUENCY-MODULATED SUPERVISORY SIGNALING FOR POLARIZATION-MULTIPLEXED SYSTEMS

(71) Applicant: Fujitsu Limited, Kawasaki-shi (JP)

(72) Inventors: Jeng-Yuan Yang, Garland, TX (US); Inwoong Kim, Allen, TX (US); Olga Vassilieva, Plano, TX (US); Motoyoshi Sekiya, Richardson, TX (US)

(73) Assignee: Fujitsu Limited, Kawasaki-shi (JP)

(21) Appl. No.: 14/080,502

(22) Filed: Nov. 14, 2013

(51) Int. Cl. H04B 10/077; H04L 27/10; H04J 14/06; H04B 10/27

(52) U.S. Cl. CPC H04B 10/077; H04B 10/27; H04L 27/10; H04J 14/06
USPC 398/16

(57) ABSTRACT

Systems and method for monitoring a dual-polarization signal are disclosed. The systems and methods include adding a first supervisory signal to a first polarization component of the dual-polarization signal to get a first combined signal and adding a second supervisory signal to a second polarization component of the dual-polarization signal to get a second combined signal, either in the electrical or optical domain. The supervisory signals are arbitrary, non-complementary, and modulated at a frequency substantially lower than the modulation frequency of the dual-polarization signal. The systems and methods further include analyzing the supervisory signals upon receipt.

### TECHNICAL FIELD

This invention relates generally to the field of optical networks and more specifically to monitoring a dual-polarization signal using an in-band supervisory signal.

### BACKGROUND

As the importance and ubiquity of optical communication systems increases, it becomes increasingly important to be able to accurately and efficiently monitor the optical communication system in order to ensure proper operation of the optical communication system. The importance of accurate and efficient monitoring increases as optical traffic signals are implemented comprising components with multiple polarizations (e.g., dual-polarization signals). It is increasingly important to be able to monitor the optical communication system in a cost-effective manner, as well as monitor in-line with other components of the optical communication system.

### SUMMARY OF THE DISCLOSURE

In accordance with certain embodiments of the present disclosure, systems and method for monitoring a dual-polarization signal are disclosed. The systems and methods include adding a first supervisory signal to a first polarization component of the dual-polarization signal to get a first combined signal and adding a second supervisory signal to a second polarization component of the dual-polarization signal to get a second combined signal, either in the electrical or optical domain. The supervisory signal is arbitrary, non-complementary, and modulated at a frequency substantially lower than the modulation frequency of the dual-polarization signal. The systems and methods further include analyzing the supervisory signal upon receipt.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example optical transmission system, in accordance with certain embodiments of the present disclosure;

FIG. 2 illustrates an example supervisory signal transmitter for adding arbitrary, non-complementary, frequency-modulating supervisory signals, in accordance with certain embodiments of the present disclosure; and

FIG. 3 illustrates an example supervisory signal transmitter 300 for adding arbitrary, non-complementary, frequency-modulating supervisory signals without the use of a digital signal processor, in accordance with certain embodiments of the present disclosure;

FIG. 4 illustrates an example supervisory signal receiver for analyzing arbitrary, non-complementary, frequency-modulating supervisory signals with minimal components, in accordance with certain embodiments of the present disclosure;

FIG. 5 illustrates an example supervisory signal receiver for analyzing the individual polarization components of arbitrary, non-complementary, frequency-modulating supervisory signals, in accordance with certain embodiments of the present disclosure; and

FIG. 6 illustrates a flowchart of an example method for analyzing a supervisory signal associated with an optical traffic signal, in accordance with certain embodiments of the present disclosure.

### DETAILED DESCRIPTION OF THE INVENTION

As used herein, the term “computer-readable media” may be any available media that may be accessed by a general purpose or special purpose computer. By way of example, and not limitation, such computer-readable media may comprise tangible computer-readable including RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. Combinations of the above should also be included within the scope of computer-readable media.

Additionally, “computer-executable instructions” may include, for example, instructions and data which cause a general purpose computer, special purpose computer, or special purpose processing device to perform a certain function or group of functions.

As used herein, the term “module” or “component” may refer to software objects or routines that execute on a computing system. The different components, modules, engines, and services described herein may be implemented as objects or processes that execute on the computing system (e.g., as separate threads), as well as being implemented as hardware, firmware, and/or some combination of all three.

The following describes a cost-effective, in-line solution for monitoring an optical traffic signal of an optical communication system. The present disclosure describes systems and methods for monitoring a relatively low-data rate supervisory signal within existing components of the optical communication system in order to monitor wavelength and lightpath information associated with the optical communication system.

Telecommunications systems, cable television systems and data communication networks use optical networks to rapidly convey large amounts of information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. The optical network may communicate supervisory data indicating any number of characteristics associated with the optical network, including source information, destination information and routing information, and other management information of the optical network.

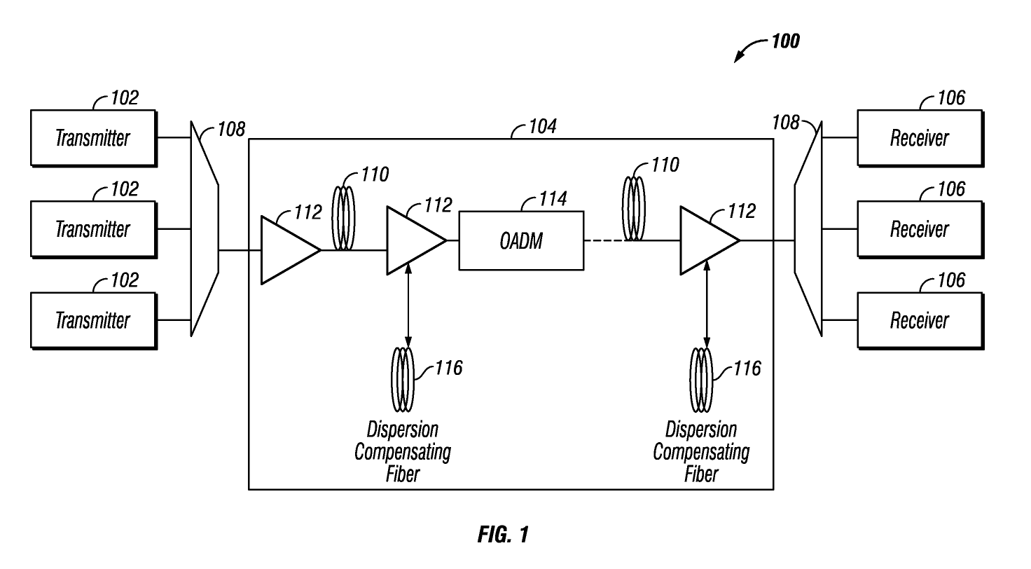

FIG. 1 illustrates an example optical network 100, in accordance with certain embodiments of the present disclosure. Network 100 may include transmitter 102, transmission system 104, and receiver 106. Network 100 may include one or more optical fibers 110 configured to transport one or more optical signals communicated by components of optical network 100. The network elements of optical network 100, coupled together by fibers 110, may include one or more transmitters 102, one or more multiplexers (MUX) 108, one or more amplifiers 112, one or more optical add/drop multiplexers (OADM) 114, and/or one or more dispersion compensating fibers 116. The example system of FIG. 1 illustrates a simplified point-to-point optical system. Although one particular form or topography of network 100 is illustrated, network 100 may take any appropriate form, including a ring network, mesh network, and/or any other suitable optical network and/or combination of optical networks.

In some embodiments, transmitter 102 may be any electronic device, component, and/or combination of devices and/or components configured to transmit a multi-polarization optical signal to receiver 106. For example, transmitter 102 may include one or more lasers, processors, memories, digital-to-analog converters, analog-to-digital converters, digital signal processors, beam splitters, beam combiners, multiplexers, and/or any other components, devices, and/or systems required to transmit a dual-polarization optical signal to receiver 106.

In some embodiments, transmitter 102 may be further configured to include a supervisory signal in-band with the optical traffic signal. The systems and methods describing one particular implementation of the supervisory signal with a dual-polarization optical signal are described in more detail in U.S. patent application Ser. No. 13/620,102, and Ser. No. 13/620,172, both of which are hereby incorporated by reference. For the purposes of this disclosure, references to an “optical signal” and/or an “optical traffic signal” should be assumed to include the in-band supervisory signal unless expressly stated otherwise.

In some configurations of network 100, it may be costly to implement an in-band supervisory signal with a dual-polarization optical signal. For example, it may be necessary to install high-speed (and thus expensive) photo-detectors, processors, and/or polarimeters. However, in other configurations of network 100, one or more low-data rate supervisory signal(s) may be implemented, allowing for the use of low-speed (and thus lower-cost) photo-detectors, processors, and/or polarimeters.

In some embodiments, a low-data rate supervisory signal may have a modulation period much longer than the data period of the optical traffic signal. In the same or alternative embodiments, the low-data rate supervisory signal(s) may allow the supervisory signal(s) to be more easily separated from a main data signal.

In some embodiments, transmitter 102 may communicate an optical traffic signal (along with one or more in-band supervisory signals) to receiver 106 via transmission system 104. Transmission system 104 may generally include the following components: one or more fiber 110, one or more OADM 114 module(s), and/or one or more amplifier(s) 112. With reference to FIG. 1, these components are provided to aid in illustration and are not intended to limit the scope of the present disclosure. In some configurations of network 100, network 100 may include more, fewer, and/or different components than those illustrated in FIG. 1.

In addition, the components of transmission system 104 may be communicatively coupled to one another through the use of fiber 110. In some embodiments, fiber 110 may be any appropriate optical fiber configured to carry data, such as a single-mode optical fiber or a non-zero dispersion shifted fiber. Transmission system 104 may also include amplifier 112. In some embodiments, amplifier 112 may be any amplifier configured to amplify the optical traffic signal (along with the one or more in-band supervisory signal) for more efficient transmission to receiver 106. For example, amplifier 112 may be an erbium doped fiber amplifier (“EDFA”) common to optical communication systems. In some embodiments, amplifier 112 may be responsible for certain types of noise introduced to the optical traffic signal. For example, an EDFA introduces a type of noise known to one of ordinary skill in the art as amplified spontaneous emission (“ASE”). In some embodiments, amplifier 112 may be communicatively coupled to dispersion compensating fiber 116. Dispersion compensating fiber 116 may be any appropriate fiber and/or collection of fibers configured to compensate for any nonlinear effects associated with transmission system 104 such as chromatic dispersion. In some embodiments, network 100 may also include one or more OADM 114. OADM 114 may be any appropriate component and/or collection of components configured to multiplex and/or route multiple wavelengths of light between and/or among nodes of network 100.

In some embodiments, receiver 106 may be any electronic device, component, and/or combination of devices and/or components configured to receive a multi-polarization optical signal from transmitter 102. For example, transmitter 102 may include one or more lasers, optical modulators, processors, memories, digital-to-analog converters, analog-to-digital converters, digital signal processors, beam splitters, beam combiners, demultiplexers, and/or any other components, devices, and/or systems required to receive a dual-polarization optical signal from transmitter 102.

In some embodiments, transmitter 102 and receiver 106 may be present in the same device, for example in an optical communication network including a plurality of optical nodes that are interconnected. In the same or alternative embodiments, transmitter 102 and receiver 106 may be separate devices, located either locally or remote from one another.

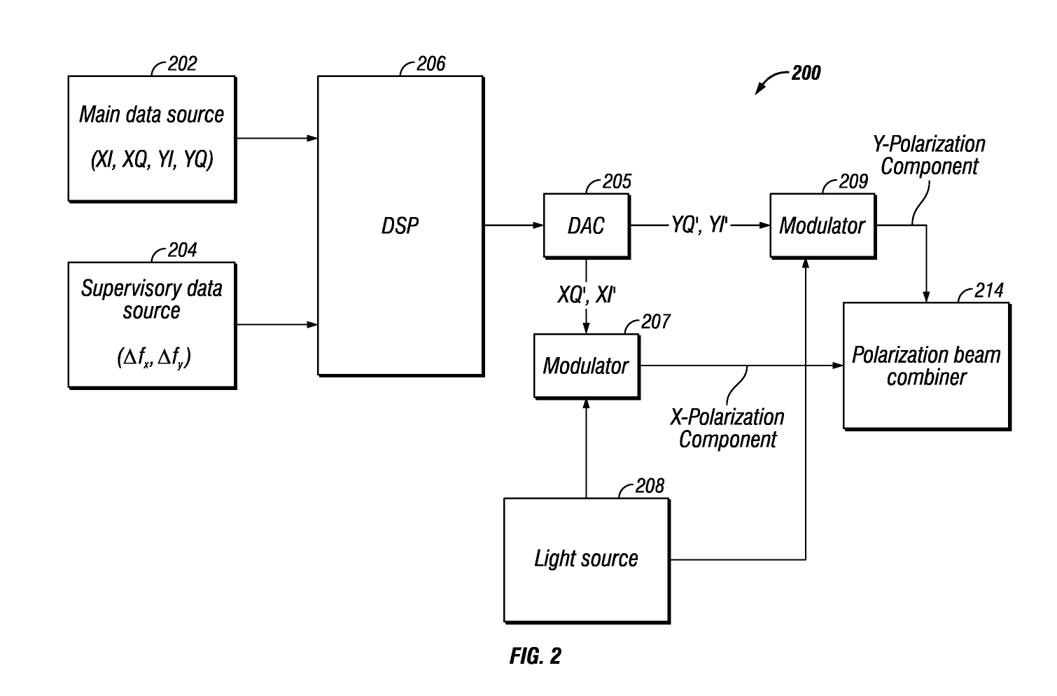

In operation, transmitter 102 may communicate a dual-polarization optical traffic signal (along with the one or more in-band supervisory signal(s)) to receiver 106 via transmission system 104. In some embodiments, transmitter 102 may communicate the dual-polarization optical traffic signal via an appropriate modulation scheme. For example, transmitter 102 may communicate the dual-polarization optical traffic signal to receiver 106 via a phase shifting modulation technique (e.g., dual-polarization quadrature phase-shift-keying (“DP-QPSK”), DP-8QAM, DP-16QAM, DP-32QAM, DP-64QAM, etc.). In some embodiments, the modulation scheme used to transmit the data portion of the dual-polarization optical traffic signal may be different from the modulation scheme used to transmit the supervisory signal. For example, transmitter 102 may communicate the supervisory signal using non-complementary frequency modulations, as described in more detail below with reference to FIGS. 2-6.

At transmitter 102, certain wavelength and/or lightpath properties associated with system 100 may be tracked for use in administering system 100. Management information associated with these properties may be included in the one or more supervisory signal(s) for communicating further along system 100.

By monitoring the supervisory signal communicated in-band with the optical traffic signal, network 100 may be able to determine the wavelength and lightpath properties associated with system 100.

FIG. 2 illustrates an example supervisory signal transmitter 200 for adding arbitrary, non-complementary, frequency-modulating supervisory signals, in accordance with certain embodiments of the present disclosure. In some embodiments, system 200 may include one or more data source(s) 202, one or more supervisory data source(s) 204, one or more digital-to-analog (“DAC”) converter(s) 205, one or more digital signal processor(s) (“DSPs”) 206, one or more modulator(s) 207, 209, one or more light source(s) 208, and one or more polarization beam combiner(s) 214.

In some embodiments, supervisory data source 204 may be configured to provide an arbitrary, non-complementary, frequency-modulated supervisory signal to DSP 206. For the purposes of the present disclosure, a non-complementary signal may be understood to be one in which the value of the x-component of the supervisory signal is not equal to the y-component of the supervisory signal, and in which the x-component of the supervisory signal does not have the opposite value of the y-component of the supervisory signal.

In some embodiments, system 200 may be configured to output data to one or more other component(s) of traffic system 100. For example, system 200 may be configured to output supervisory signal data from supervisory data source 204 and/or monitored signal data from main data source 202. As described in more detail below and with reference to FIGS. 1 and 3-6, supervisory signal data may be configured to include wavelength information, lightpath information, and/or any other appropriate information relative to traffic system 100.

In some embodiments, DSP 206 and light source 208 may be part of a commercially-available transmitter 102. For example, DSP 206 may be a commercially-available digital signal processor integrated into, and/or configured to work alongside other components of transmitter 102. In this way, system 200 may be configured to provide a relatively lower-cost alternative to implementation in a traffic system 100 in which digital signal processors are used with and/or in transmitter 102 by not requiring additional components.

In some embodiments, DSP 206 may be configured to combine the main data from main data source 202 with the data from supervisory data source 204 in the electrical domain such that no additional optical components may be required for in-band supervisory signal modulation. In some configurations, the modulation rate for the supervisory signal may be slow compared to the rate of the main data (e.g., a supervisory signal modulated at a MHz scale for main data at a GHz scale). In some embodiments, transmitter 200 may also include one or more DACs 205. DAC 205 may be any components or components configured to convert the digitally-combined signals into analog signal for use in combination with modulator(s) 207 and/or light source(s) 208 in order to generate a combined optical data signal with a plurality of polarization components.

In some embodiments, transmitter 200 may also include one or more modulator(s) 207, 209. Modulators 207, 209 may be configured to modulate the incoming signal according to a provided driving signal. In some embodiments, the driving signal may be set according to the supervisory signal data and/or the main signal data. For example, the driving signal for modulator 207 (e.g., the modulator associated with the x-component of the signal) may be denoted as XI′ and XQ′ and the driving signal for modulator 209 (e.g., the modulator associated with the y-component of the signal) may be denoted as YI′ and YQ′.

In some embodiments, transmitter 200 may also include one or more polarization beam combiner(s) 214 configured to combine the plurality of polarization components of the combined optical signal into a single optical signal for communication to other components of optical system 100.

In some embodiments, the variation to the main data caused by the addition of the supervisory signal may result in additional fluctuation of the laser frequency by transmitter 102. In some embodiments, this variation may be removed by laser frequency offset compensation algorithms built into commercially available DSPs at receiver 106.

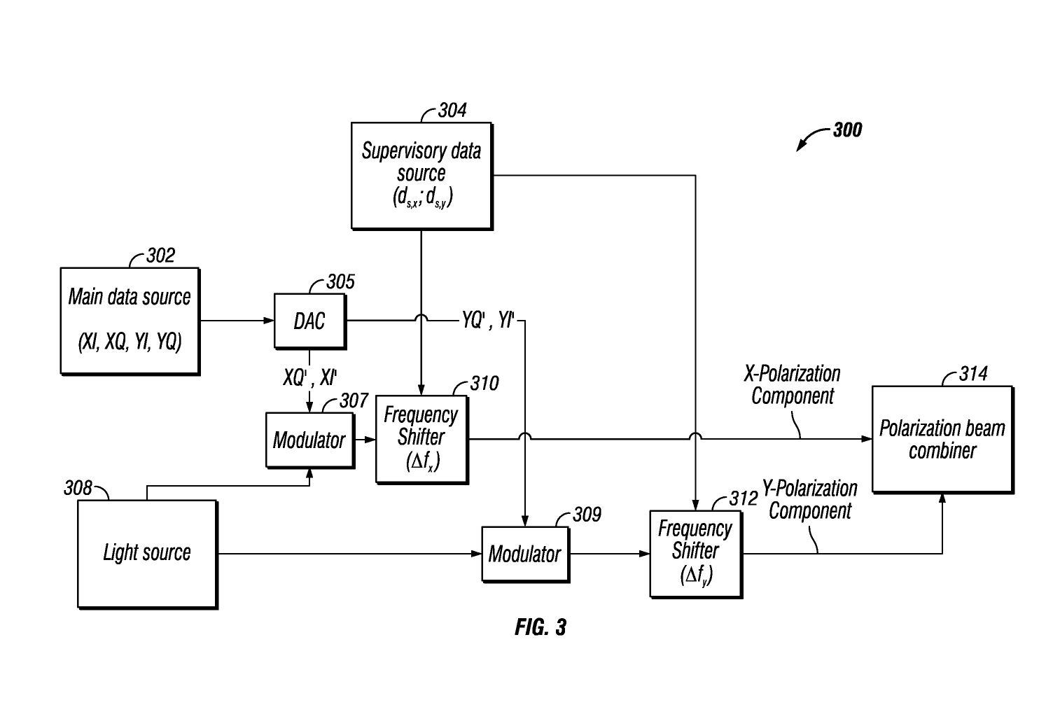

FIG. 3 illustrates an example supervisory signal transmitter 300 for adding arbitrary, non-complementary, frequency-modulating supervisory signals without the use of a digital signal processor, in accordance with certain embodiments of the present disclosure. In some embodiments, system 300 may include one or more main data source(s) 302, one or more supervisory data source(s) 304, one or more digital-to-analog converter(s) (“DAC”) 305, one or more modulator(s) 307, 309, one or more light source(s) 308, one or more frequency shifter(s) 310, 312 and one or more polarization beam combiner(s) 314.

In some embodiments, system 300 may also include a digital signal processor. However, in configurations such as that illustrated by FIG. 3, the digital signal processor may not be needed for the addition of data from supervisory data source(s) 304.

As described above with reference to FIG. 2, light source 308 (and/or a digital signal processor if one is present) may be part of a commercially available optical transmitter 102. In some embodiments, transmitter 200 may also include one or more DACs 305. DAC 305 may be any components or components configured to convert the digitally-combined signals into analog signal for use in combination with modulator(s) 307 and/or light source(s) 308 in order to generate a combined optical data signal with a plurality of polarization components.

In some embodiments, transmitter 300 may also include one or more modulator(s) 307, 309. Modulators 307, 309 may be configured to modulate the incoming signal according to a provided driving signal. In some embodiments, the driving signal may set according to the supervisory signal data and/or the main signal data. For example, the driving signal for modulator 307 (e.g., the modulator associated with the x-component of the signal) may be denoted as XI′ and XQ′ and the driving signal for modulator 309 (e.g., the modulator associated with the y-component of the signal) may be denoted as YI′ and YQ′.

In some embodiments, system 300 may also include one or more frequency shifter(s) 310, 312. Each frequency shifter 310, 312 may be configured to change the frequency of modulated data from main data source 302 in order to include one or more components of data from supervisory data source 304. For example, frequency shifter 310 may be configured to add an x-component of the supervisory signal to the x-component of the main data signal. Frequency shifter 312 may be configured to add a y-component of the supervisory signal to the y-component of the main data signal. The amount of the frequency shift introduced by frequency shifters 310, 312 may be configured to reflect the values of the x- and y-components of the supervisory signal.

In some embodiments, the signal output from frequency shifters 310, 312 may be combined at polarization beam combiner 314. The main data signal, offset by the supervisory signal may then be communicated from polarization beam combiner 314 to transmission system 104.

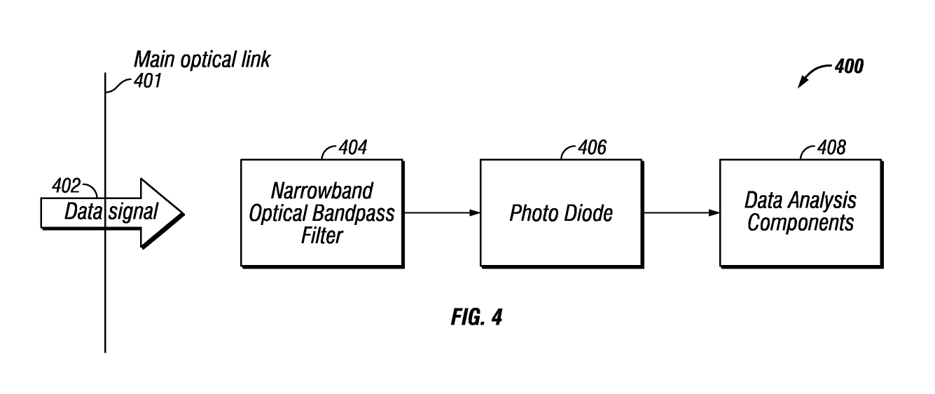

FIG. 4 illustrates an example supervisory signal receiver 400 for analyzing arbitrary, non-complementary, frequency-modulating supervisory signals with minimal components, in accordance with certain embodiments of the present disclosure. In some embodiments, system 400 may include data signal 402, one or more optical band-pass filter(s) 404, one or more photo diode(s) 406, and one or more data analysis component(s) 408.

In some embodiments, data signal 402 may include an optical traffic signal along with a superimposed supervisory signal, as described in more detail above with reference to FIGS. 1-3. Data signal 402 may be pulled from main optical link 401. In some embodiments, main optical link 401 may be any communication path transmitting an optical signal along a portion of optical system 100. For example, receiver 400 may tap main optical link 401 to produce data signal 402, which may have 5-10% of the optical power of the signal travelling along main optical link 401.

In some embodiments, optical band-pass filter 404 may be configured to extract the x- and y-components of the supervisory signal. For example, optical band-pass filter (“BPF”) may be a tunable BPF configured to pass the x- and/or y-components of the supervisory signal. In conjunction with photo diode 406, receiver 400 may be configured to convert the frequency-modulated supervisory signal into an amplitude-modulated supervisory signal. In some embodiments, photo diode 406 may be a relatively low-speed photo diode due to the relatively low modulation speed of the supervisory signal. Once the supervisory signal data has been extracted, it may be passed to one or more data analysis component(s) 408.

In some embodiments, data analysis component(s) 408 may be any component configured to analyze the extracted supervisory signal. For example, data analysis component(s) 408 may include a power meter, digital signal processor, microprocessor, microcontroller, and/or any appropriate component configured to analyze the extracted supervisory signal data. For example, data analysis component 408 may be a power meter configured to analyze the extracted supervisory signal data for an optical power level. As another example, data analysis component 408 may be a microprocessor configured to gather wavelength information, lightpath information, etc., from the extracted supervisory signal data.

In some embodiments, BPF 404 may be included in one or more data analysis component(s) 408. For example, data analysis component 408 may be a digital signal processor configured to implement a narrowband optical BPF. In such a configuration, data analysis components(s) 408 may analyze both the x- and y-components of the supervisory data signal simultaneously.

In some embodiments, the relatively low cost of the components included in receiver 400 may allow receiver 400 to be implemented in-line in traffic system 100. In the same or alternative embodiments, the components of receiver 400 may be included in a stand-alone optical receiver, and/or any other appropriate configuration of optical receiver(s).

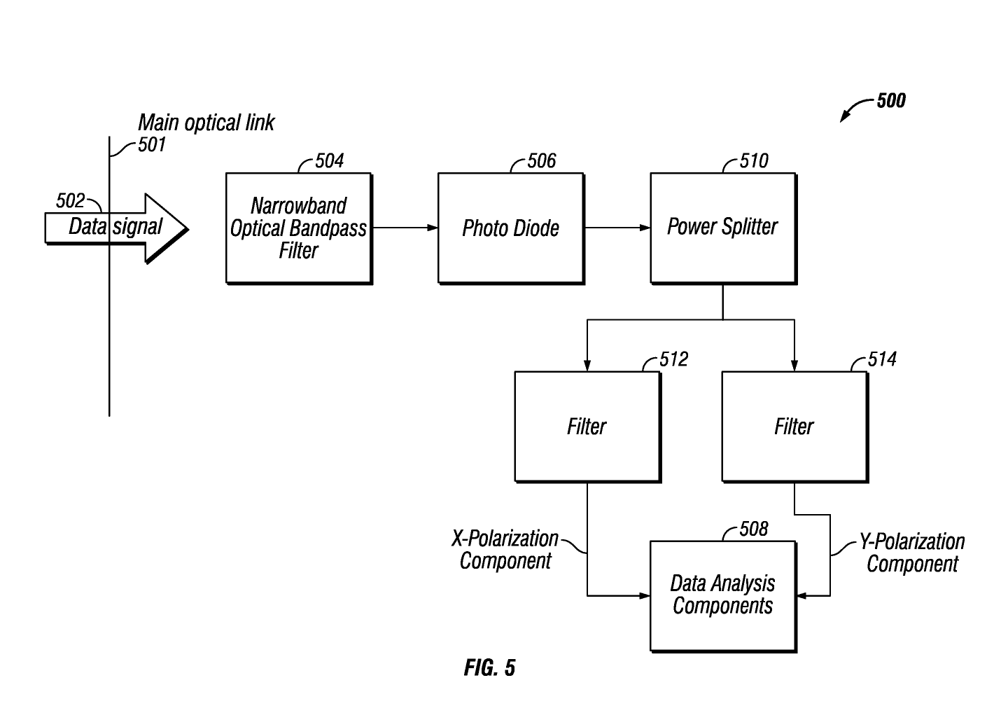

FIG. 5 illustrates an example supervisory signal receiver 500 for analyzing the individual polarization components of arbitrary, non-complementary, frequency-modulating supervisory signals, in accordance with certain embodiments of the present disclosure. In some embodiments, system 500 may include data signal 502, one or more narrowband optical band-pass filter(s) 504, one or more photo diode(s) 506, one or more power splitter(s) 510, one or more filter(s) 512, 514, and one or more data analysis component(s) 508.

In some embodiments, data signal 502 may include an optical traffic signal along with a superimposed supervisory signal, as described in more detail above with reference to FIGS. 1-3. Data signal 502 may be pulled from main optical link 401. In some embodiments, main optical link 501 may be any communication path transmitting an optical signal along a portion of optical system 100. For example, receiver 500 may tap main optical link 501 to produce data signal 502, which may have 5-10% of the optical power of the signal travelling along main optical link 501.

Narrowband optical band-pass filter 504 may be configured to extract the x- and y-components of the supervisory signal. For example, optical band-pass filter (“BPF”) may be a tunable BPF configured to pass the x- and/or y-components of the supervisory signal. In conjunction with photo diode 506, receiver 500 may be configured to convert the frequency-modulated supervisory signal into an amplitude-modulated supervisory signal. In some embodiments, photo diode 506 may be a relatively low-speed photo diode due to the relatively low modulation speed of the supervisory signal. Once the supervisory signal data has been extracted, it may be passed to one or more power splitter(s) 510.

Power splitter 510 may be any appropriate component configured to separate the x- and y-components of the supervisory signal data. For example, power splitter 510 may be configured to pass the supervisory signal data to a first filter 512 that may extract data associated with the x-component of the supervisory signal data, and to a second filter 514 that may extract data associated with the y-component of the supervisory signal data.

In some embodiments, filters 512, 514 may be configured as band-pass filters to further extract the individual polarization components of the supervisory signal data before passing the data onto one or more data analysis component(s) 508. In the same or alternative embodiments, one or more of filters 512, 514 may be configured as a low-pass filter. For example, filter 512 may be configured as a low-pass filter to filter the lowest frequency component.

In some embodiments, the data analysis required for data analysis component(s) 508 may be reduced due to the prior separation of the individual polarization components of the supervisory signal data. In some configurations, this may reduce the load and/or complexity required of data analysis component(s) 508.

As described in more detail above with reference to FIG. 4, data analysis component(s) 508 may be any component configured to analyze the extracted supervisory signal. For example, data analysis component(s) 408 may include a power meter, digital signal processor, microprocessor, microcontroller, and/or any appropriate component configured to analyze the extracted supervisory signal data. For example, data analysis component 408 may be a power meter configured to analyze the extracted supervisory signal data for an optical power level. As another example, data analysis component 408 may be a microprocessor configured to gather lightpath information from the extracted supervisory signal data.

In some embodiments, the relatively low cost of the components included in receiver 500 may allow receiver 500 to be implemented in-line in traffic system 100. In the same or alternative embodiments, the components of receiver 500 may be included in a stand-alone optical receiver, and/or any other appropriate configuration of optical receiver(s).

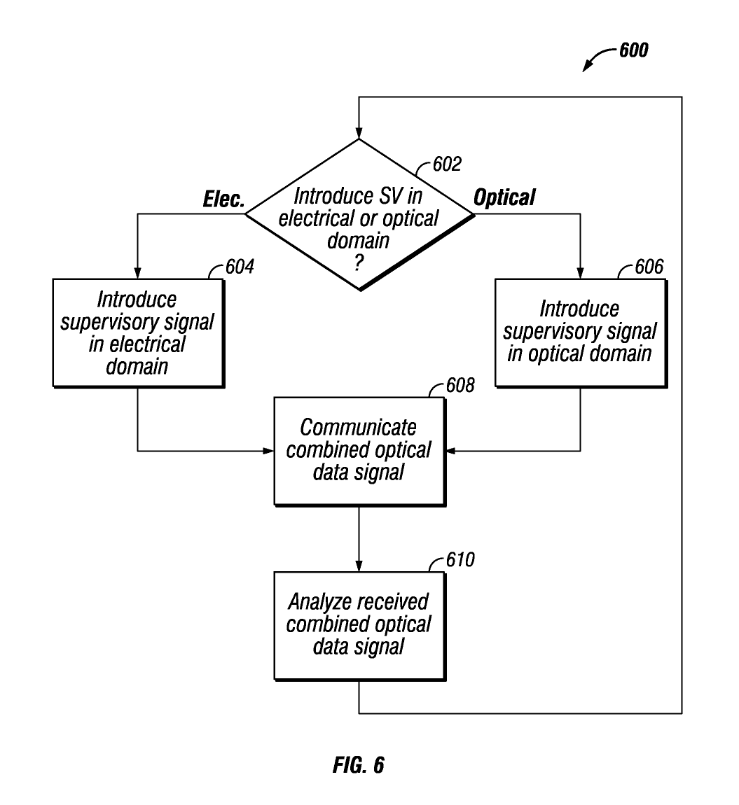

FIG. 6 illustrates a flowchart of an example method 600 for analyzing a supervisory signal associated with an optical traffic signal, in accordance with certain embodiments of the present disclosure. Method 600 may include introducing an arbitrary, non-complementary, frequency-modulated supervisory signal, filtering, the supervisory signal data from the main data signal, and analyzing the supervisory signal data.

According to one embodiment, method 600 may begin at 602. Teachings of the present disclosure may be implemented in a variety of configurations. As such, the preferred initialization point for method 600 and the order of 602-610 comprising method 600 may depend on the implementation chosen.

At 602, method 600 may determine whether to introduce the supervisory signal data in the electrical domain or the optical domain, as described in more detail above with reference to FIGS. 1-3. If the supervisory signal is to be introduced via the electrical domain, method 600 may proceed to step 604. If the supervisory signal is to be introduced via the optical domain, method 600 may proceed to step 606.

At step 604, method 600 may introduce a supervisory signal to an optical data signal in the electrical domain, as described in more detail above with reference to FIGS. 1-2. For example, method 600 may introduce a supervisory signal with both an x- and a y-component to a dual-polarization data signal. In some embodiments, this may include using a digital signal processor to combine the supervisory signal data from a supervisory data source with main signal data from a main data source. After introducing the supervisory signal data, method 600 may proceed to step 608.

Referring again to step 606, method 600 may introduce a supervisory signal to an optical data signal in the optical domain, as described in more detail above with reference to FIGS. 1 and 3. For example, method 600 may introduce a supervisory signal with both an x- and a y-component to a dual-polarization data signal. In some embodiments, this may include using a plurality of frequency shifters and/or a polarization beam combiner to combine the supervisory signal data from a supervisory data source with main signal data from a main data source. After introducing the supervisory signal data, method 600 may proceed to step 608.

At step 608, method 600 may communicate the combined optical data signal through the remainder of traffic system 100. For example, transmitter 102 may communicate the combined optical data signal (e.g., the combination of the main data and the supervisory signal) to another component of traffic system 102. After communicating the combined optical data signal, method 600 may proceed to step 610.

At step 610, method 600 may analyze the received combined optical data signal in order to determine information included in the supervisory signal data, as described in more detail above with reference to FIGS. 1-5. For example, method 600 may use a plurality of filters, photo diodes, and/or data analysis components to separate the individual polarization components of the supervisory signal from the combined optical data signal. As described in more detail above with reference to FIGS. 4-5, this may be done in line with traffic system 100 and/or by certain components of receiver 106. In some embodiments, the analysis may include determining certain information associated with the supervisory signal, e.g., the optical power, wavelength information, lightpath information, etc. After analyzing the combined optical data signal, method 600 may return to step 602 to begin the process again.

Although FIG. 6 discloses a particular number of steps to be taken with respect to method 600, method 600 may be executed with more or fewer than those depicted in FIG. 6. For example, in some configurations of traffic system 100, the analysis of the supervisory signal data may occur simultaneously with further communication of the combined optical data signal (e.g., when performing in-line analysis). Further, in some configurations of traffic system 100, both electrical domain and/or optical domain combinations of the main data signal data and supervisory signal data may be performed.

What is claimed:

1. A method for monitoring a dual-polarization signal, the method comprising:
in the electrical domain, adding a first supervisory signal to a first polarization component of the dual-polarization signal to get a first combined signal; and
in the electrical domain, adding a second supervisory signal to a second polarization component of the dual-polarization signal to get a second combined signal, wherein the first and second supervisory signals are:
non-complementary; and
modulated at a frequency substantially lower than the modulation frequency of the dual-polarization signal.

2. The method of claim 1, further comprising combining the first combined signal and the second combined signal into a combined data signal.

3. The method of claim 2, further comprising communicating the combined data signal.

4. The method of claim 2, further comprising filtering the first supervisory signal from the combined data signal.

5. The method of claim 4, further comprising analyzing the first supervisory signal to determine wavelength information associated with the first polarization component of the dual-polarization signal.

6. The method of claim 4, further comprising analyzing the first supervisory signal to determine lightpath information associated with the first polarization component of the dual-polarization signal.

7. The method of claim 2, further comprising filtering the second supervisory signal from the combined data signal.

8. The method of claim 7, further comprising analyzing the second supervisory signal to determine wavelength information associated with the second polarization component of the dual-polarization signal.

9. The method of claim 7, further comprising analyzing the second supervisory signal to determine lightpath information associated with the second polarization component of the dual-polarization signal.

10. A method for monitoring a dual-polarization signal, the method comprising:
in the optical domain, adding a first supervisory signal to a first polarization component of the dual-polarization signal to get a first combined signal; and
in the optical domain, adding a second supervisory signal to a second polarization component of the dual-polarization signal to get a second combined signal, wherein the first and second supervisory signals are:
non-complementary; and
modulated at a frequency substantially lower than the modulation frequency of the dual-polarization signal.

11. The method of claim 10, further comprising combining the first combined signal and the second combined signal into a combined data signal.

12. The method of claim 11, further comprising communicating the combined data signal.

13. The method of claim 11, further comprising filtering the first supervisory signal from the combined data signal.

14. The method of claim 13, further comprising analyzing the first supervisory signal to determine wavelength information associated with the first polarization component of the dual-polarization signal.

15. The method of claim 13, further comprising analyzing the first supervisory signal to determine lightpath information associated with the first polarization component of the dual-polarization signal.

16. The method of claim 11, further comprising filtering the second supervisory signal from the combined data signal.

17. The method of claim 16, further comprising analyzing the second supervisory signal to determine wavelength information associated with the second polarization component of the dual-polarization signal.

18. The method of claim 16, further comprising analyzing the second supervisory signal to determine lightpath information associated with the second polarization component of the dual-polarization signal.

19. An optical transmitter comprising:
a main data source configured to generate a main data signal including a first polarization component and a second polarization component;
a supervisory data source configured to generate a first supervisory signal and a second supervisory signal, wherein the first and second supervisory signals are non-complementary, frequency-modulated supervisory signals;
a digital signal processor configured to:
add the first supervisory signal to the first polarization component of the main signal to get a first combined signal; and
add the second supervisory signal to the second polarization component of the main data signal to get a second combined signal.

20. An optical transmitter comprising:
a main data source configured to generate a main data signal including a first polarization component and a second polarization component;
a supervisory data source configured to generate a first supervisory signal and a second supervisory signal, wherein the first and second supervisory signals are non-complementary, frequency-modulated supervisory signals;
a first frequency shifter configured to add the first supervisory signal to the first polarization component of the main signal to get a first combined signal;
a second frequency shifter configured to add the second supervisory signal to the second polarization component of the main data signal to get a second combined signal; and
a polarization beam combiner configured to combine the first combined signal and the second combined signal.

21. An optical receiver for analyzing a combined optical signal, the optical receiver comprising:
a first filter configured to filter an individual supervisory signal from the combined optical signal;
a data analysis component configured to extract information from the individual supervisory signal, wherein the individual supervisory signal is a non-complementary, frequency-modulated supervisory signal.

22. The receiver of claim 21, further comprising a processor configured to execute instructions stored on computer-readable media, the instructions when executed causing the processor to perform a frequency offset compensation algorithm in order to offset frequency variations introduced by the individual supervisory signal.

23. The receiver of claim 21, wherein the data analysis component is configured to extract wavelength information from the supervisory signal.

24. The receiver of claim 21, wherein the data analysis component is configured to extract lightpath information from the supervisory signal.
